(19) United States
(12) Patent Application Publication
(10) Pub. No.: US 2010/0265927 A1
(43) Pub. Date: Oct. 21, 2010

(54) Efficient Allocation of Power to Bandwidth In a Multi-Carrier Cellular Communication System

(75) Inventors: Daniel Davidson MacFarlane Shearer, III, Scottsdale, AZ (US); Ronald Duane McCallister, Scottsdale, AZ (US)

Correspondence Address: MESCHKOW & GRESHAM, P.L.C., 7250 NORTH SIXTEENTH STREET, SUITE 318, PHOENIX, AZ, 85020-5279, US

(73) Assignee: CrestCom, Inc., Scottsdale, AZ (US)

(21) Appl. No.: 12/427,272

(22) Filed: Apr. 21, 2009

(51) Int. Cl. H04W 84/02; H04J 1/00

(52) U.S. Cl. 370/338; 370/343

(57) ABSTRACT

A cellular communication system includes a plurality of base stations (20), each of which assigns all frequency division multiplex, forward link carriers (32) to either a high-power set (42) of carriers (32) or a low-power set (44) of carriers (32) to improve system capacity and reduce boundary interference in a K=1 frequency reuse plan. The low-power set (44) has fewer members than the high-power set (42). The carriers (32) are simultaneously transmitted, preferably from an omnidirectional antenna (26). Access terminals (76) are configured to select carriers (32) from low-power set (44) for the receipt of data from base stations (20) when such carriers (32) from low-power set (44) provide an acceptable data rate, even though other carriers (32) may have higher SINR.

### TECHNICAL FIELD OF THE INVENTION

The present invention relates generally to the field of cellular communication systems. More specifically, the present invention relates to the allocation of carriers to cells or sectors in a multi-carrier communication system and to the power levels at which the carriers are transmitted.

### BACKGROUND OF THE INVENTION

A limited amount of the radio frequency (RF) spectrum is available for the public's many and varied communication applications. A cellular approach to spectrum use has become popular in recent decades in order to use the limited spectrum more efficiently. In accordance with the cellular approach, rather than serving only one customer at a time using a high power transmission in a given larger area, the larger area is divided into cells, customers communicate directly with base stations in the cells, the base stations are not the ultimate source or destination of the customer's communications but merely move the communications toward the destination, and an allocated RF bandwidth is reused in several cells within the larger area. This cellular approach leads to a more efficient use of the limited available RF spectrum due to the reuse of the spectrum within the larger area.

But in spite of a wide variety of different approaches to cellular communications, conventional systems have failed to efficiently allocate power to their allocated bandwidths, resulting in reduced system capacity. FIGS. 1-4 graphically show different representative conventional cellular frequency reuse plans. FIGS. 1 and 2 respectively show K=3 and K=4 frequency reuse plans, where K is the number of frequency patterns used throughout a larger area. Thus, frequency patterns “A”, “B”, and “C” (FIG. 1) or “A”, “B”, “C”, and “D” (FIG. 2) are repeated an indefinite number of times throughout the larger area in order to provide reasonably complete radio coverage over the larger area. The letters “A”, “B”, and so on represent individual frequency division multiplex (FDM) carriers or mutually exclusive sets of such carriers.

FIGS. 1 and 2 together show that a reuse distance, which is the distance at which a frequency pattern is reused, increases as K increases. An increased reuse distance is desirable because increased distances reduce interference between users of the same spectrum in different cells. At the boundaries between the cells in FIGS. 1 and 2, little interference should be experienced, in theory, because path loss for an interfering signal from the nearest cell using the same frequency pattern should attenuate the interfering signal sufficiently for reception at the boundaries. But the benefit of reduced interference comes at a cost in the efficient use of the spectrum. For the K=3 example of FIG. 1, only 33% of the available spectrum is used in any single cell; and, for the K=4 example of FIG. 2, only 25% of the available spectrum is used in any single cell. In the past, K=7 reuse patterns (not shown) were popular, using only 14% of the available spectrum in any single cell.

One way to increase system capacity is to shrink cell size and thereby increase the number of times that the allocated spectrum is reused in a given larger area. Cell sizes are reduced by reducing the power at which carriers are transmitted. But as cell size shrinks more base stations are needed. And, as cell size shrinks, so does the path loss through the cells where frequency patterns lay fallow. In other words, at a given power level, path loss increases nonlinearly, at an increasing rate, as distance from a transmitting antenna increases. Thus, for a high power, large cell, low reuse, frequency plan, the K=3 reuse pattern of FIG. 3 may be adequate, but for a moderate power, medium size cell, the K=3 reuse pattern may have excessive interference, particularly at the cell boundaries. The excessive interference may be addressed by moving to a higher frequency pattern number, such as K=4 or K=7, but that causes less of the available spectrum to be used in any single cell. This loss of available spectrum for use in any given cell offsets much of the system capacity gains achieved by shrinking cell size.

FIG. 3 graphically shows a representative conventional K=1 cellular frequency reuse plan. FIG. 3 shows that the entire spectrum available to the cellular system is available for use in each cell. Here, “A”, “B”, . . . , and “N” represent any number of discrete FDM carriers. In the K=1 example, 100% of the spectrum is available for use in each cell, but interference is a problem. All carriers of any given cell are transmitted at equal power. At the boundaries between cells, each carrier from one cell is as strong as the same carrier for the adjacent cell. Communication is difficult at the cell boundaries due to interference. On the other hand, 100% of the available spectrum is used in each cell to offset the moderation in system capacity caused by boundary interference. And, the real world boundary-interference problem of the K=1 frequency reuse plan of FIG. 3 may not be as far different from the K=3 and K=4 frequency reuse plans of FIGS. 1 and 2 as FIGS. 1-3 may suggest. Unlike the regular hexagons depicted in FIGS. 1-3, which depict complete coverage with no overlap, real world radio coverage areas in any frequency reuse plan are irregular closed-curve shapes that most likely to have numerous gaps and overlaps between adjacent cells. Accordingly, K=1 frequency reuse plans are reasonably efficient at using the available spectrum. They are compatible with smaller cell sizes, and they use 100% of the spectrum in each cell. But they suffer from a cell-boundary interference problem that moderates system capacity improvements and provide gaps in coverage over the larger area due to boundary interference problems.

Conventional cellular systems have also addressed the boundary interference problem of K=1 reuse plans. In a technique called “proportional frequency reuse,” associated with orthogonal frequency division multiplex (OFDM) communication systems, different modulation techniques are applied to different subcarriers, and the patterns of subcarrier modulation techniques differ for adjacent cells. The different modulation techniques essentially cause data communicated over some subcarriers to be communicated at a greater energy per bit level than data communicated over other subcarriers, even though each subcarrier is transmitted at the same power level as the others. As a result, an improved likelihood exists that an access terminal at a boundary will be able to engage in at least some level of communication with one or both of the adjacent cells. But the likelihood of being unable to engage in any communications at the boundary is still significant, and boundary communications tend to take place at low data rates.

FIG. 4 shows a K=1/K=3 hybrid frequency reuse plan associated with Evolution-Data Optimized (EV-DO) communication systems compatible with the TIA-856, Rev. B communication standard, which is incorporated herein, in its entirety, by reference. The FIG. 4 example is applied to a sectorized system, unlike the omnidirectional systems depicted in FIGS. 1-3. In FIG. 4, a single carrier “A” is reused in each sector. Thus, the hybrid frequency reuse plan is a K=1 reuse plan with respect to carrier “A”. But carriers “B”, “C”, and “D” are distributed in accordance with a K=3 frequency reuse plan. After hybridizing the K=1 and K=3 reuse plans, only 50% of the available spectrum is used in each sector. Throughout the interior of each sector, the K=1 carrier (“A”) and one of the K=3 carriers (“B”, “C”, or “D”) are available for non-interfering use. At the boundaries between sectors, a single K=3 carrier from one sector and a different K=3 carrier from an adjacent sector are available for non-interfering use. The K=1 carrier (“A”) is likely to be unavailable at the boundaries due to interference. With the hybrid frequency reuse plan, a high likelihood of being able to engage in boundary communications at reasonable data rates exists. But system capacity is diminished because 50% of the spectrum is unavailable for use in each sector.

The cell sectorization, depicted in FIG. 4, represents another conventional way to increase system capacity. Compared to the omnidirectional examples of FIGS. 1-3, capacity is increased up to three fold due to sectorization alone, and sectorization may be applied to any of the FIGS. 1-3 frequency reuse plan examples. But sectorization does not cure the above-discussed problems of applying multiple carriers to distinct geographical regions, whether they are configured as cells or as sectors. And, sectorization requires the use of expensive and unsightly directional antennas, which are far larger, more expensive, and more unsightly when used at frequencies less than 1.3 GHz.

Accordingly, a need exists for a multi-carrier cellular communication system that achieves an efficient use of the spectrum while supporting boundary communications. A further need exists for a multi-carrier cellular communication system that uses inexpensive base stations, is compatible with smaller cell sizes, and can take advantage of inexpensive and less obtrusive omnidirectional antennas.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a prior art K=3 frequency reuse plan;

FIG. 2 shows a prior art K=4 frequency reuse plan;

FIG. 3 shows a prior art K=1 frequency reuse plan;

FIG. 4 shows a prior art K=1/K=3 hybrid frequency reuse plan;

FIG. 5 shows a block diagram of a base station configured in accordance with one embodiment of the present invention;

FIG. 6 shows a graph of a plurality of frequency-division multiplexed (FDM) forward link carriers distributed throughout a radio-frequency bandwidth when transmitted by the base station of FIG. 5;

FIGS. 7A-7G show a first view of a first example of a multi-carrier frequency reuse plan implemented by neighboring base stations in accordance with one embodiment of the present invention, with different carriers being depicted in different ones of FIGS. 7A-7G;

FIG. 8 shows a second view of the multi-carrier frequency reuse plan depicted in FIGS. 7A-7G;

FIG. 9 shows a block diagram of an access terminal configured in accordance with one embodiment of the present invention;

FIG. 10 shows an exemplary flow chart of one embodiment of a “searcher” process performed by the access terminal of FIG. 9;

FIG. 11 shows an exemplary flow chart of one embodiment of a “receive control message” process performed by the access terminal of FIG. 9;

FIG. 12 shows an exemplary flow chart of one embodiment of an “active set” process performed by the access terminal of FIG. 9;

FIG. 13 shows a second example of a multi-carrier frequency reuse plan implemented by neighboring base stations in accordance with one embodiment of the present invention;

FIG. 14 shows a third example of a multi-carrier frequency reuse plan implemented by neighboring base stations in accordance with one embodiment of the present invention; and

FIG. 15 shows a fourth example of a multi-carrier frequency reuse plan implemented by neighboring base stations in accordance with one embodiment of the present invention;

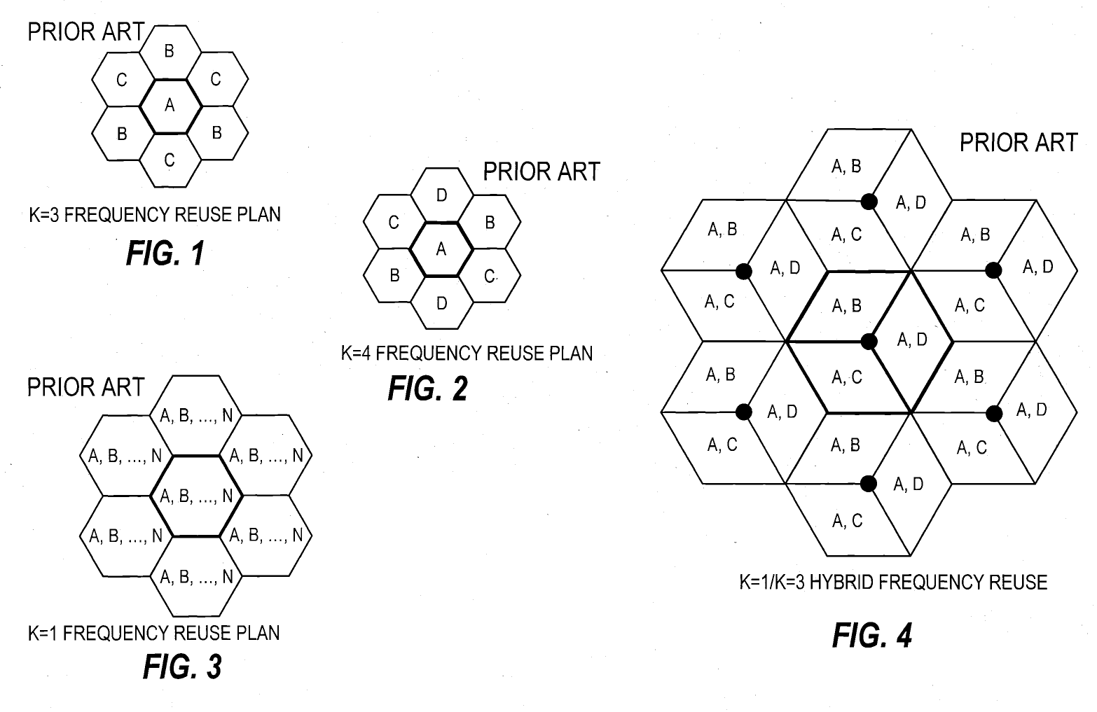

### DETAILED DESCRIPTION OF THE PREFERRED EMBODIMENTS

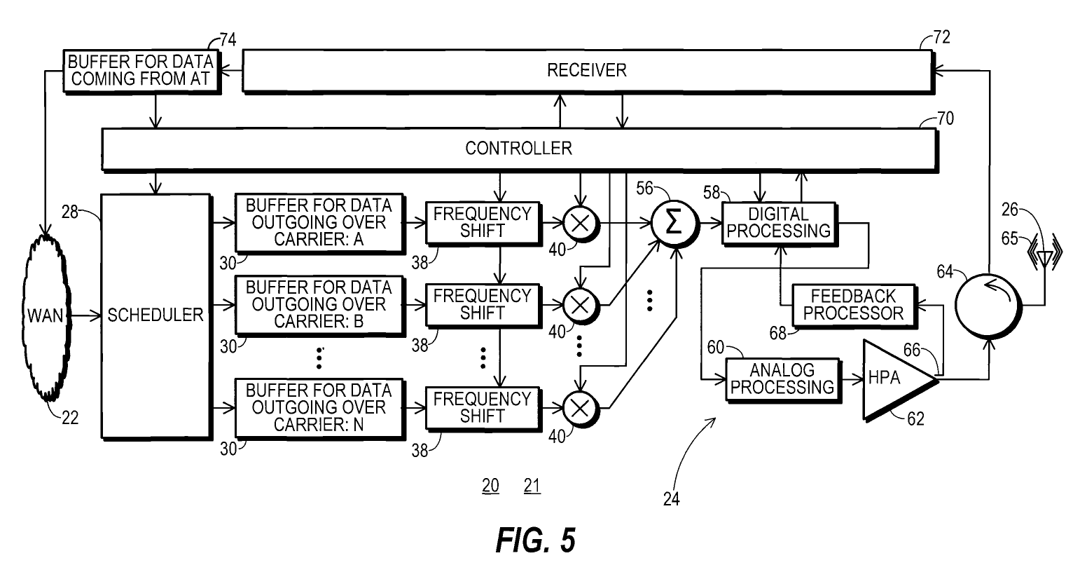

FIG. 5 shows a block diagram of a single base station 20 used in a communication system 21 and configured in accordance with one embodiment of the present invention. Base station 20 is particularly relevant for use in an Evolution-Data Optimized (EV-DO) communication system compatible with the TIA-856, Rev. B communication standard, but that is not a requirement of the present invention. Those skilled in the art may adapt the teaching provided herein to other types of communication systems, including but not limited to WIMAX systems compatible with an IEEE 801.16 communication standard. At least a plurality of base stations 20 configured substantially as depicted in FIG. 5 are included in communication system 21.

Base station 20 couples to a wider area network (WAN) 22, which may be provided by the Internet, a public switched telecommunications network, or the like. Base station 20 has one or more transmitters 24, although FIG. 5 depicts an embodiment that includes only one transmitter 24. Transmitter 24 couples to an antenna 26 in a one-to-one correspondence. For every transmitter 24, one antenna 26 is provided. Throughout communication system 21, at least a plurality of transmitters 24 and antennas 26 are provided. In the preferred embodiment, antenna 26 is an omnidirectional antenna due to its smaller size and cost when compared to a directional antenna. But in other embodiments any type of antenna system known to those of skilled in the art may serve as antenna 26, including a directional antenna, antennas having any number of elements, elements driven by a common source or driven by independent sources, and the elements spaced apart in a variety of different configurations.

The use of an omnidirectional antenna 26 is desirable because it reduces costs and it reduces size. While reducing cost and size are usually desirable goals, they are particularly relevant base station goals in a cellular communication system. Smaller cell sizes do much to increase system capacity. But smaller cell sizes require a larger number of transmitters and antennas for reasonably complete coverage over a larger area. Smaller sizes and costs therefore accommodate increased system capacity by permitting the use of a greater number transmitters and antennas within a given larger area.

With respect to data flowing from WAN 22 toward antenna 26, a scheduler 28 of base station 20 routes the data to various digital buffers 30. A separate buffer 30 is provided for each frequency division multiplex (FDM) forward link carrier to be transmitted by each transmitter 24. Forward link carriers are transmitted from base stations while reverse links are received at base stations. In accordance with this embodiment, transmitter 24 is capable of simultaneously transmitting data over all FDM forward link carriers allocated to communication system 21 for use in the larger area within which base station 20 operates.

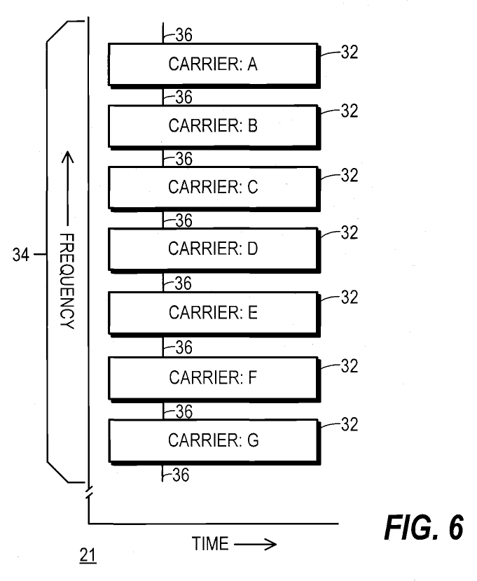

FIG. 6 shows a graph of a plurality of FDM forward link carriers 32 distributed throughout a radio-frequency (RF) bandwidth 34 and transmitted by transmitter 24. FIG. 6 depicts one embodiment in which 10 MHz of RF bandwidth 34 is allocated to communication system 21 for use in the larger area within which base station 20 operates. This particular bandwidth is not a requirement of the present invention, but is consistent with the size of blocks of bandwidth made available to communication system providers by governmental licensing agencies. RF bandwidth 34 may be located anywhere in the RF electromagnetic spectrum, including at frequencies less than 1.3 GHz. The use of omnidirectional antennas 26 at frequencies less than 1.3 GHz is particularly desirable because the cost and size savings associated with omnidirectional antennas are particularly significant at lower frequencies.

This 10 MHz of RF bandwidth 34 is divided into seven carriers 32, also labeled A, B, C, D, E, F, and G, which are distributed throughout RF bandwidth 34. If each carrier is approximately 1.25 MHZ wide, which is compatible with EV-DO communication systems, then the seven carriers 32 collectively occupy approximately 8.75 MHZ of the 10 MHz bandwidth 34, and the remaining 1.25 MHz is distributed as guard bands 36. But the use of guard bands 36 is not a requirement of the present invention. Different numbers of carriers 32 and different carrier 32 bandwidths may be provided in different embodiments. Each carrier 32 may also be multiplexed in the time domain, with different time slots and/or frames being used by different access terminals (not shown), and/or each carrier may be multiplexed through direct sequence spread spectrum (DSSS) coding.

Referring to FIGS. 5-6, the majority of data flowing to scheduler 28 from WAN 22 is intended for those access terminals within the radio coverage area of transmitter 24 capable of receiving radio-frequency (RF) communication signals transmitted from transmitter 24. The access terminals are generally viewed as being subscribers of communication system 21. Scheduler 28 has knowledge of which access terminals are receiving data over which carriers, as will be described in more detail below. A conventional scheduler, such as a proportional fairness scheduler used in EV-DO communication systems, may be used for scheduler 28. One buffer 30 is provided for each carrier 32. In accordance with its scheduling algorithms and based on the knowledge about which access terminal is receiving which carrier at any given instant, scheduler 28 routes the data to the appropriate buffer 30.

Buffers 30 may also drive conventional digital processes (not shown) known to those skilled in the art, such as digital coding, digital modulation, direct sequence spread spectrum (DSSS) coding, and the like. Such coding and modulation activities may be carried out in accordance with digital rate control (DRC) codes provided to base station 20 from the access terminals for which the data streams are intended. Eventually, the individual data streams intended for the different carriers 32 are routed to frequency shift sections 38 to achieve the relative frequency spacing between carriers 32 depicted in FIG. 6, except that carriers 32 are still positioned at or near baseband. The individual data streams also pass through respective gain sections 40, where signal amplitudes are adjusted to determine the relative power levels at which carriers 32 will be transmitted.

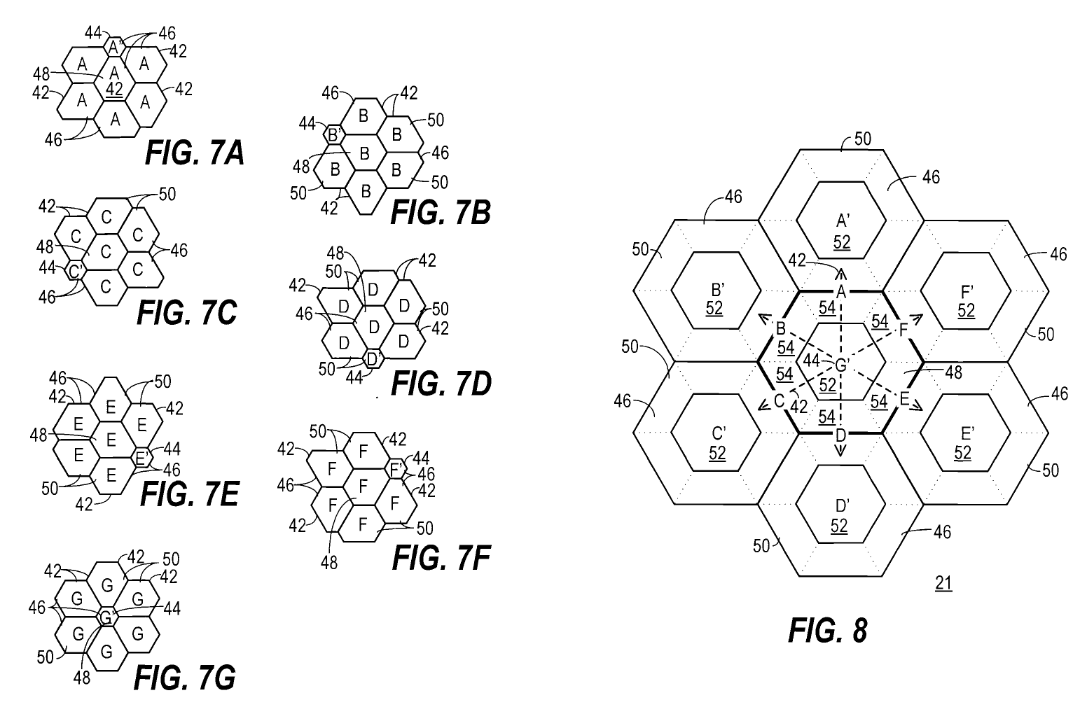

FIGS. 7A-7G together show a first view of a first example of a multi-carrier frequency reuse plan implemented by neighboring base station transmitters 24 in accordance with one embodiment of the present invention, with different carriers being depicted in different ones of FIGS. 7A-7G. Desirably, all neighboring base stations 20 are configured similarly. Referring to FIGS. 5 and 7A-7G, frequency shift and gain sections 38 and 40 together assign each carrier 32 to either a high-power set 42 of carriers 32 or a low-power set 44 of carriers 32. All of carriers 32 are assigned by frequency shift and gain sections 38 and 40, and different base stations 20 likewise assign all of carriers 32 for their respective transmitters 24. The identity assignment of the carrier 32 in which data are transmitted is determined by a respective frequency shift section 38, and the power level assignment is determined by a respective gain section 40.

But the relative power levels that are assigned to the carriers 32 in gain sections 40 of the different base stations 20 tend to differ from one another, as is explained in more detail below. In FIGS. 7A-7G, the carrier or carriers 32 assigned to low-power set 44 of carriers 32 is denoted and distinguished from those carriers 32 assigned to high-power set 42 by the use of an appended apostrophe to the carriers' letter designation, A-G. The assignments of carriers 32 to high-power and low-power sets 42 and 44 are static assignments. In other words, the assignments undergo little or no change over an extended period of time which spans a multiplicity of frames, the assignments are not responsive to any particular access terminal to which a transmitter 24 may be transmitting, and the assignments are not responsive to any particular location where an access terminal may be positioned.

The reuse plan depicted in FIGS. 7A-7G is consistent with the seven-carrier communication system example shown in FIG. 6. Each of FIGS. 7A-7G depicts the assignment of a different one of the seven carriers. Each of FIGS. 7A-7G depicts seven geographically distinct regions 46 for which transmitters 24 are provided in a one-to-one correspondence and for which antennas 26 are provided in a one-to-one correspondence. In FIGS. 7A-7G, regions 46 are depicted as cells formed by the use of omnidirectional antennas 26. Antennas 26 are physically located in the central portion of each region 46. But in other embodiments, regions 46 may be configured as sectors formed by the use of directional antennas 26. Each of carriers 32 is repeatedly reused throughout regions 46. Each of carriers 32 is preferably reused in each region 46 to achieve a reuse pattern of K=1. Thus, data may be simultaneously transmitted over every carrier 32 in every region 46.

The same seven regions 46 are repeatedly depicted in each of FIGS. 7A-7G. The seven regions 46 include a central region 48 surrounded by its six adjacent distinct geographical regions 50. The overall area collectively covered by the seven regions 46 depicted in each of FIGS. 7A-7G most likely is but a portion of a larger area within which a communication service provider provides cellular communication services. But reasonable coverage is provided for that larger area by repeating the patterns shown in FIGS. 7A-7G as needed. By repeating the patterns shown in FIGS. 7A-7G into additional regions, each region 46 may be classified both as a central region 48 that has its own six adjacent distinct regions 50, and as an adjacent region 50 to six different central regions 48.

Those skilled in the art will appreciate that FIGS. 7A-7G depict regions 46 in accordance with a hexagonal schema. In actual practice, regions 46 will tend not to have boundaries with corners or straight lines, and the antennas 26 whose transmissions define regions 46 are typically not spaced equal distances apart or in precisely repeatable patterns. This hexagonal schema of FIGS. 7A-7G depicts each region 46 as being either a smaller regular hexagonal shape or a larger elongated hexagonal shape. The smaller regular hexagonal shapes denote carriers 32 assigned to low-power set 44 of carriers 32 and the larger elongated hexagonal shapes denote carriers 32 assigned to high-power set 42 of carriers 32. Collectively, FIGS. 7A-7G show that in this example, each region 46 includes one member in low-power set 44 of carriers 32 and each region 46 also includes six members in high-power set 42 of carriers 32. And, a carrier 32 (e.g., carrier G′) assigned to low power set 44 in central region 48 is assigned to high power set 42 in all its adjacent regions 50. The assignment of a single carrier 32 to low-power set 44 of carriers 32 is desirable for an EV-DO example because, it permits a large amount of bandwidth 34 to be used at higher power for spectrum efficiency, while also permitting a large number of surrounding regions 46 to reuse that single carrier 32 that large number of times, at higher power, to mitigate boundary interference issues. And, the use of that single carrier at higher power in surrounding regions 46 compensates for the small amount of local spectrum efficiency loss caused from using the single carrier 32 at lower power.

Gain sections 40 in each base station 20 are adjusted so that the strongest member of low-power set 44 for the base station 20 is transmitted at lower power than the weakest member of high-power set 42. For more efficient use of the bandwidth, the difference between the power levels of the carriers 32 included in the two sets desirably makes a noticeable and significant difference in radio coverage ranges. In other words, the strongest member of low-power set 44 is desirably significantly lower than the weakest member of high-power set 42. Preferably, the relative power assigned to carriers 32 in low-power set 44 is greater than 0.001 times the average power for all carriers transmitted from a given transmitter 24. And, more preferably the relative power assigned to carriers 32 in low-power set 44 is greater than 0.05 times the average power for all carriers 32 transmitted from a given transmitter 24. In addition, the relative power assigned to carriers 32 in low-power set 44 is less than the average power for all carriers 32 transmitted from a given transmitter 24, and more preferably less than 0.5 times the average power for all carriers assigned to high power set 42. In the preferred embodiment, all carriers in high-power set 42 are transmitted at approximately the same high power level and all carriers in low-power set 44 are transmitted at approximately the same low power level, but this is not a requirement. The use of these relative power levels achieves improvements in system-wide capacity in comparison with conventional equal power, K=1 frequency reuse plans and with K=1/K=3 hybrid frequency reuse plans.

Moreover, preferably only a few carriers 32 are assigned to low-power set 44 relative to the number of carriers 32 assigned to high-power set 42. In order to efficiently apply power to the RF bandwidth 34 (FIG. 6), all carriers 32 available to system 21 are assigned to either high-power set 42 or low-power set 44, at least one carrier 32 is assigned to high-power set 42, and at least one carrier 32 is assigned to low-power set 44. And, preferably the number of members included in low-power set 44 is at most 50% of the number of carriers 32 assigned to high-power set 42, with a single member in low-power set 44 being preferred for many applications. In one embodiment, zero power carriers may be assigned to low-power set 44, so long as there are but a few of them. In other words, in one embodiment a carrier 32 is assigned to low-power set 44 for a particular region 46 by not using that carrier 32 in that region 46 or by letting that carrier 32 go fallow in that region 46. But the exact numbers of carriers 32 assigned to high-power and low-power sets 42 and 44 will differ from application to application for maximum system capacity depending on the number of carriers 32 being reused throughout the larger system coverage area and the number of nearby regions 46 whose high-power reuse of a low-power carrier 32 can contribute to reducing boundary interference. Nevertheless, within each region, different FDM forward link carriers 32 are transmitted at different power levels. In comparison to a conventional, equal power, K=1 frequency reuse plan, each carrier in high-power set 42 is transmitted at a slightly higher power level and each carrier in low-power set 44 is transmitted at a significantly lower power level. The elongation of the hexagonal shapes in FIGS. 7A-7G for regions 46 of high-power set 42 is primarily due to the lower power level, and hence smaller coverage area, of the same carrier 32 transmitted in an adjacent region 50.

FIG. 8 shows a second view of the multi-carrier frequency reuse plan depicted in FIGS. 7A-7G. FIG. 8 shows the same seven regions 46 which are also depicted in each of FIGS. 7A-7G. In FIG. 8, all carriers 32 are combined in one figure, but specifically identified only for central region 48. Only low-power sets 44 of carriers 32 are labeled in adjacent regions 50. FIG. 8 shows that when all carriers 32 are viewed together, each region 46 includes a core zone 52 and six distinct boundary zones 54. Core zone 52 is the radio coverage area of the carriers 32 included in low-power set 44 in a region 46. At the edges of core zone 52, the signal-to-noise-and-interference ratio (SINR) of that carrier 32 should roughly equal the SINR of that same carrier 32 transmitted from one of the adjacent regions 50, where in the adjacent region 50 that same carrier 32 is included in a high-power set of carriers 42. And, since different adjacent regions 50 have different carriers 32 assigned in their low-power sets 44, different boundary zones 54 for those different higher power carriers of central region 48 extend to the core zones 52 in the adjacent regions 50.

The use of different power levels for different carriers 32 in adjacent regions 50 causes different carriers 32 to experience different boundaries. The different boundaries are most clearly observed by comparing central region 48 for the seven different carriers depicted in FIGS. 7A-7G. One carrier 32 has a more symmetrical or circular pattern surrounding a small area, and six carriers 32 have unsymmetrical or elongated patterns, where the directions of elongation are different between the six carriers 32. As a consequence, carriers assigned to low-power set 44 may be heavily loaded in core zone 52, carriers 32 assigned to high-power set 42 may be heavily loaded in boundary zones 54, and the data traffic self-organizes into sectors while using omnidirectional antennas 26. Each carrier 32 assigned to high-power set 42 is heavily loaded in the direction where that same carrier 32 has been assigned in an adjacent region's low-power set 44 because its SINR is greater here due to reduced interference from the same carrier at lower power in the adjacent region 50. Thus, system capacity is improved and boundary interference is reduced because different carriers experience different boundaries. An improvement in the efficient allocation of power to bandwidth is achieved.

Referring back to FIG. 5, outputs from gain sections 40 couple to respective inputs of a combiner 56, where they are added together to form a single wideband data stream representing the combination of the individual data streams directed to individual carriers 32. An output of combiner 56 couples to a digital processing section 58. Section 58 may apply different types of digital processing to the wideband signal, such as peak-to-average-power ratio (PAPR) reduction and/or predistortion. An output of section 58 couples to an analog processing section 60. Section 60 may apply different types of analog processing to the wideband signal, including analog conversion, upconversion to RF frequency band 34 (FIG. 6), filtering, and the like. After processing in section 60, the wideband signal is supplied to a high-power amplifier (HPA) 62 for final amplification, then to a circulator or duplexer 64, which couples to antenna 26. At antenna 26, a wideband RF signal 65, including all carriers 32 combined therein, is transmitted away from transmitter 24 of base station 20.

At a directional coupler 66, a small portion of amplified wideband RF signal 65 may be extracted and routed to a feedback processor 68. Feedback processor 68 processes the RF signal for use by digital processing section 58 in crafting desirable forms of PAPR reduction and predistortion.

A controller 70 is also provided for base station 20 and coupled to scheduler 28, each frequency shift section 38, each gain section 40, and digital processing section 58. Controller 70 is desirably configured through the execution of software to cause frequency shift sections 38 and gain sections 40 to implement the above-discussed assignments of carriers 32 to high-power set 42 and low-power set 44. Controller 70 couples to scheduler 28 in order to send control data to access terminals. Such control data may include an active set of carriers from which the access terminals make selections as to the carriers from which data will be received, the identification of a preferred channel, and other control data items conventional in the art. The preferred channels are channels preferred by communication system 21 to be selected at access terminals for the receipt of data. As is discussed in more detail below, the preferred channels are those carriers 32 assigned to a transmitter's low-power set 44.

Base station 20 may include a receiver 72, as is conventional in the art. Receiver 72 has an input coupled to circulator or duplexer 64 and an output which drives a buffer 74 for data arriving from access terminals (AT). Receiver 72 is desirably configured to receive, downconvert, demodulate, decode, and demultiplex the reverse links from access terminals, under the control of controller 70. After this processing, the data received from the access terminals are placed in buffer 74, where the majority of such data are sent to WAN 22. But control data received from access terminals over the reverse links may instead be routed from buffer 74 to controller 70. Such control data may include data rate control (DRC) codes and other conventional control data.

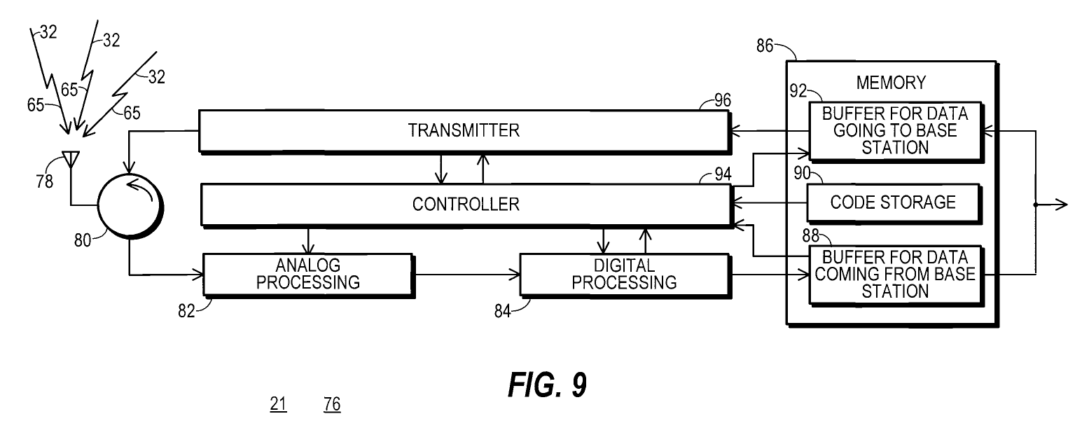

FIG. 9 shows a block diagram of an access terminal 76 configured in accordance with one embodiment of the present invention. Access terminal 76 is an RF device which engages in RF communications with any base station 20 of communication system 21 within radio range. In particular, access terminal 76 is configured to receive FDM forward link carriers 32 and to transmit signals to base stations 20 over reverse links. And, access terminal 76 may be configured to simultaneously receive over multiple carriers 32 in accordance with the EV-DO, rev. B communications standard or other communications standards. Access terminal 76 may reside at any location within any region 46 (FIG. 8) of communication system 21, and in a typical scenario, a multiplicity of access terminals 76 may be active within the larger communication system at any given instant.

Access terminal 76 includes an antenna 78 at which RF energy falling into RF bandwidth 34 (FIG. 6) is received. This RF energy may include a number of different carriers 32 transmitted both from a closest base station transmitter 24 and from other base station transmitters 24 located further away, along with multipath signals from such carriers and noise. The carriers 32 may have been assigned in their respective transmitter's high-power set 42 and/or low-power set 44 (FIG. 8).

Antenna 78 sends a received signal through a circulator 80 to an analog processing section 82. Analog processing section 82 may perform amplification, downconversion, and analog-to-digital conversion. After processing in section 82, the received signal is routed to a digital processing section 84. In section 84, the received signal may be demodulated, decoded, and demultiplexed to recover the data conveyed over carriers 32. An output of section 84 couples to a memory section 86. Memory section 86 includes a buffer 88 for data coming from base stations 20, a code storage section 90, and a buffer 92 for data going to base stations 20. One output of buffer 88 couples to output devices (not shown), for access terminal 76, such as voice and/or video decoders, a speaker, displays, and the like. One input to buffer 92 couples to input devices (not shown) for access terminal 76, such as a key pad, microphone, camera, voice and/or video encoders, and the like.

A controller 94 couples to analog and digital processing sections 82 and 84 as well as to buffers 88 and 92 and to code storage section 90. Controller 94 manages the RF reception, transmission and general operation of access terminal 76. Controller 94 performs its management operations in accordance with programming software stored in code storage section 90. Control data received from base stations 20 are obtained at controller 94 from buffer 88, and control data generated at controller 94 for sending to base stations 20 are placed in buffer 92.

A transmitter 96 receives data to be transmitted to a base station 20 from buffer 92 and operates under the control of controller 94 to digitally encode, modulate, multiplex, and upconvert the data for transmission over a reverse link. An output of transmitter 96 couples to circulator 80, through which a transmission signal is routed to antenna 78 and broadcast over the reverse link.

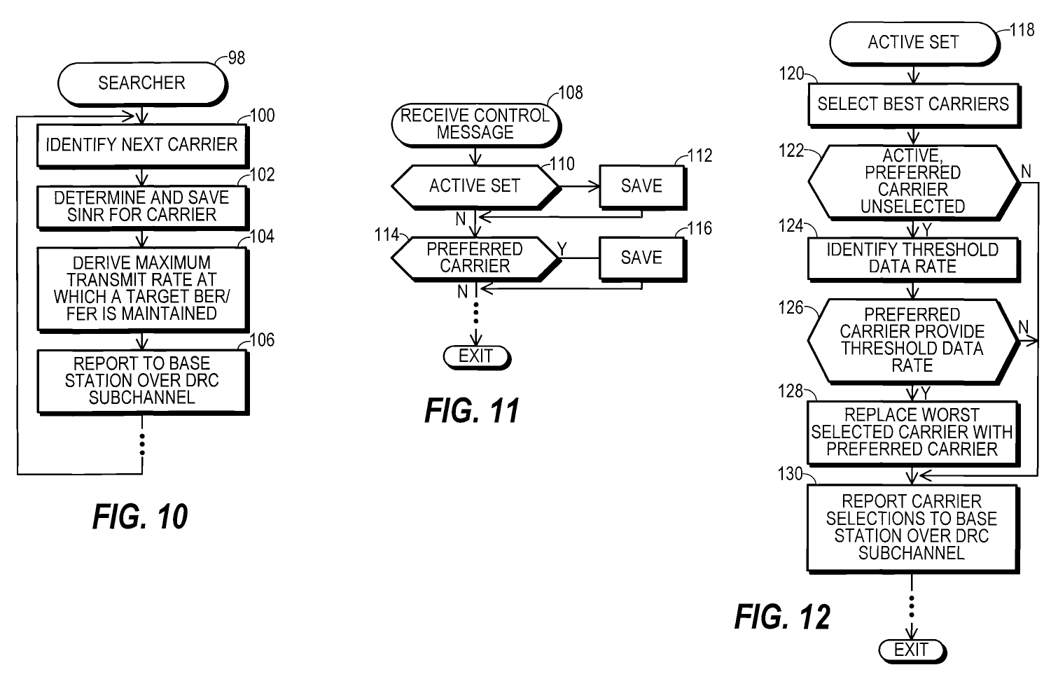

Controller 94 and more generally access terminal 76, perform a wide variety of different processes under the control of code segments stored in code storage section 90 and executed by controller 94. FIGS. 10-12 depict exemplary flow charts for three of such processes.

FIG. 10 shows an exemplary flow chart of one embodiment of a searcher process 98 performed by access terminal 76. During searcher process 98, access terminal 76 uses analog processing section 82 and/or digital processing section 84 to estimate SINR for the various carriers 32 it can receive and reports control data derived from the SINR estimates to a base station 20.

In particular, searcher process 98 includes a task 100, wherein a next carrier 32 is identified. In the depicted embodiment, each carrier 32 is identified in turn, and searcher process 98 continuously loops to repeatedly estimate SINR values for all received carriers 32. After task 100, a task 102 determines and saves an SINR for the carrier 32 identified in task 100. SINR may be determined in a conventional manner, such as through the use of pilots included in each time slot of each carrier 32, averaged over a number of time slots, or in any other convenient and effective manner.

After determining and saving an SINR value in task 102, a task 104 derives a maximum transmit rate at which a target bit-error-rate (BER) and/or frame-error-rate (FER) is maintained. In accordance with the EV-DO example, 12-15 data rate control (DRC) codes are defined which produce a variety of different data rates. Each DRC code effectively defines a specific code rate, modulation order, packet size, preamble size, and number of time slots needed to transmit a single packet. The DRC codes do not specify base station transmit power, but specify other parameters that control the energy per bit at which data may be transmitted from a base station 20 over an FDM forward link carrier 32. Task 104 translates the SINR value determined in task 102 into a DRC code compatible with the highest data rate that can be supported at the indicated SINR.

Then, following task 104, a task 106 reports the DRC code, and/or other data derived from SINR, to a base station 20. Task 106 may, for example, be performed by having controller 94 place data describing the DRC code in buffer 92 (FIG. 9) so that the data will be transmitted to a base station 20 over a reverse DRC subchannel. Following task 106, program control loops to task 100 to evaluate SINR for another carrier 32. As indicated by ellipsis in FIG. 10, any number of additional tasks may also be included in searcher process 98 before returning to task 100.

FIG. 11 shows an exemplary flow chart of one embodiment of a receive control message process 108 also performed by the access terminal 76. Process 108 may be performed interspersed with or performed simultaneously with the tasks of process 98 (FIG. 10) or process 108 may be performed while process 98 is temporarily halted. During process 108, access terminal 76 evaluates data received from a base station 20 and handles any control data addressed to access terminal 76 that may be found.

Process 108 includes a query task 110 which determines whether a control message represents a newly updated active set from base station 20. An active set represents a list of FDM forward link carriers 32 to which access terminal 76 may tune in order to continue receiving data. The base station 20 may construct the active set in response to the DRC reports from access terminal 76 discussed above in connection with task 106 (FIG. 10) and other factors as may be conventional in connection with EV-DO and other communication systems. If an active set control message is detected as being addressed to the access terminal 76, the active set data are saved in a task 112 to keep a local active set updated with the latest data.

Whether or not an active set control message is detected, a query task 114 is eventually executed to determine whether a control message is a preferred carrier message. A preferred carrier message may be directed to any access terminal 76 which can receive a base station's transmissions and need not be addressed to any specific access terminal. The preferred carrier message identifies one or more carriers 32 that communication system 21 deems to be preferred for receiving forward link data from transmitters 24. More specifically, the preferred carriers are those one or more carriers 32 included in the transmitter's low-power set 44 of carriers 32. As discussed below in connection with FIG. 12, access terminal 76 will select a preferred carrier when the preferred carrier appears to provide an acceptable data rate, even though that acceptable data rate may not be better than other data rates provided by other carriers. When a preferred carrier control message is detected in task 114, a task 116 saves the identities of the one or more specified preferred carriers.

Whether or not a preferred carrier message is detected, programming control eventually exits process 108. But as indicated by ellipsis in FIG. 11, any number of additional tasks may also be included in process 108 before exiting.

FIG. 12 shows an exemplary flow chart of one embodiment of an active set process 118 performed by access terminal 76. Process 118 may be performed by access terminal 76 to process the current active set of carriers 32 and to select one or more carriers over which data will be received. Process 118 may be performed interspersed with or performed simultaneously with the tasks of processes 98 (FIG. 10) and 108 (FIG. 11), or process 118 may be performed while processes 98 and 108 are temporarily halted.

When access terminals 76 are located in core zones 52 (FIG. 8), their measured SINR's for preferred carriers 32 assigned to that region's low-power set 44 are most likely acceptable but less than SINRs measured for carriers 32 assigned to that region's high-power set 42. During process 118, access terminal 76 evaluates received carriers 32 and reports carrier selections to the base station 20. Generally, carriers 32 having higher SINRs are selected and reported, but process 118 biases the selection process toward preferred carriers that nevertheless provide acceptable data rates.

Process 118 includes a task 120 at which the best one or more carriers 32 are temporarily selected. The best carriers may be selected by evaluating SINR values for all carriers 32 included in the active set saved as discussed above in connection with task 102 (FIG. 10) and task 112 (FIG. 11). Next, a query task 122 determines whether any preferred carriers 32 from the active set were unselected. Preferred carriers may be identified from the data saved as discussed above in connection with task 116 (FIG. 11), or in any other convenient manner. If access terminal 76 is located in a boundary zone 54 (FIG. 8), then preferred carriers are likely not to be included in the active set. But if access terminal 76 is located in a core zone 52 (FIG. 8), then preferred carriers 32 are likely included in the active set, but not selected in task 120 as one of the best carriers. In this situation, a task 124 identifies a threshold data rate, wherein the threshold data rate is deemed by communication system 21 as being a minimum acceptable data rate.

Task 124 may be performed in a variety of different ways to bias the best-carrier selection to favor preferred carriers. In a typical implementation of task 124, a small offset may be added to the measured SINR of the preferred carriers for the sole purpose of making a selection. Thus, the acceptable threshold data rate would be identified as being a data rate achievable with a carrier having an SINR within that small offset of the SINR for the carriers 32 having the highest SINR values. Or, task 124 may determine whether the data rate achievable on preferred carriers is equal to or perhaps one to four DRC code steps below the data rate achievable on the carriers having the highest SINR. In this implementation of task 124, the threshold data rate would be set one to four steps below the maximum data rate achievable by any single one of the carriers 32. Alternatively, task 124 may identify an acceptable threshold data rate as simply being above a minimum SINR or DRC code. Preferably, task 124 avoids identifying the threshold data rate as being far slower than a maximum data rate achievable in a single carrier having the highest SINR.

Following task 124, a query task 126 determines whether any preferred carriers will provide at least the threshold data rate identified above in task 124. Task 126 may be carried out, for example, by comparing an adjusted SINR for a preferred carrier with the SINR of the best carriers selected above in task 120. Task 126 may alternatively be carried out by performing a DRC translation from SINR similar to that performed in task 104 (FIG. 10) and comparing the translated DRC codes with DRC codes for the best carriers selected above in task 120 or with a threshold DRC code. When access terminal 76 is located near or in a boundary zone 54 (FIG. 8), it is likely that task 126 will fail to determine that at least the threshold data rate can be provided. But when access terminal 76 is located near or in a core zone 52 (FIG. 8), it is likely that task 126 will determine that at least the threshold data rate can be provided by a preferred carrier. When task 126 determines that at least the threshold data rate can be provided by a preferred carrier, a task 128 replaces the worst of the carriers selected above in task 120 with the one or more preferred carriers determined by task 126 as providing at least the threshold data rate.

Following task 128, when query task 122 fails to identify a preferred carrier as being unselected from the active set, and/or when query task 126 determines that no preferred carrier will provide an acceptable data rate, a task 130 is performed to report the carrier selections to base station 20 over the DRC subchannel, or in any other convenient manner. At some point following the execution of task 130, programming control eventually exits process 118. But as indicated by ellipsis in FIG. 12, any number of additional tasks may also be included in process 118 before exiting.

As a result of performing process 118, one or more carriers 32 are selected at access terminal 76 and reported to a base station 20. Base station 20 will start routing data addressed to access terminal 76 over those one or more selected carriers 32. Process 118 causes access terminal 76 to select a carrier 32 from low-power set 44 of carriers 32 when the low-power carriers 32 have a lower SINR than the SINR of other carriers 32. And, process 118 causes access terminal 76 to identify a threshold data rate that is less than or equal to a maximum data rate expected from a single one of the FDM forward link carriers received at access terminal 76. By favoring preferred carriers, which are those carriers included in a base station's low-power set 44 of carriers 32, in the selection process, access terminals 76 tend to select the preferred carriers when access terminals 76 are located in core zones 52. This makes communication capacity available in carriers 32 assigned to the base station's high-power set 42 for use by access terminals 76 located in boundary zones 54. Consequently, the data traffic load is evenly distributed across all carriers 32 regardless of access terminal 76 location.

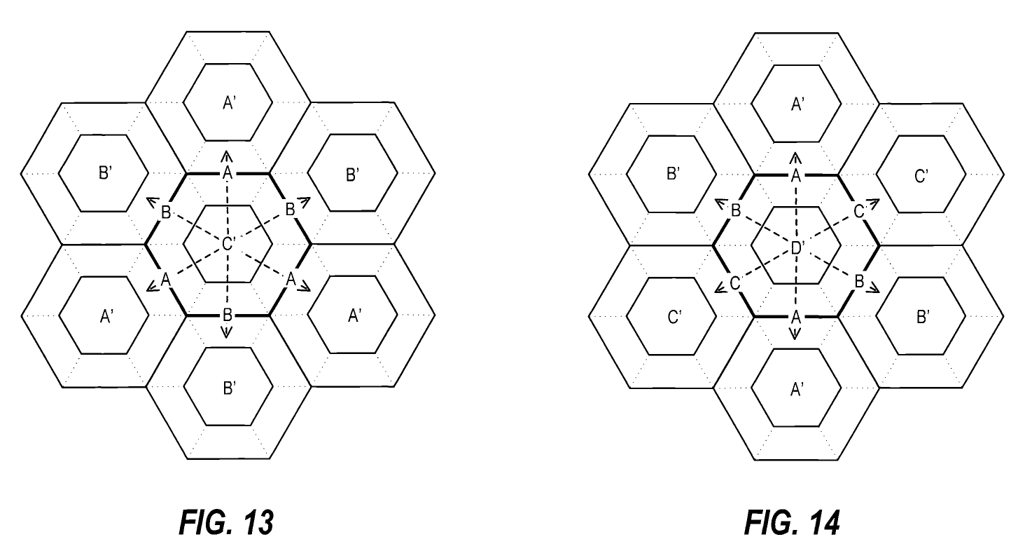

FIGS. 13-15 show alternate examples of multi-carrier frequency reuse plans according to the teaching of the present invention and carried out in communication system 21 by base stations 20 and access terminals 76. In FIG. 13, three carriers 32 (labeled A, B, and C) are used in a K=1 reuse plan which uses omnidirectional antennas 26 (FIG. 5) so that regions 46 form cells. Low-power set 44 of carriers 32 includes only a single carrier 32 for each region 46, and high-power set 42 of carriers 32 includes two carriers 32 for each region 46. But the assignments of carriers 32 to the high-power and low-power sets 42 and 44 differ in different regions 46 so that a high-power version of a carrier 32 is repeatedly adjacent to a low-power version of the same carrier 32.

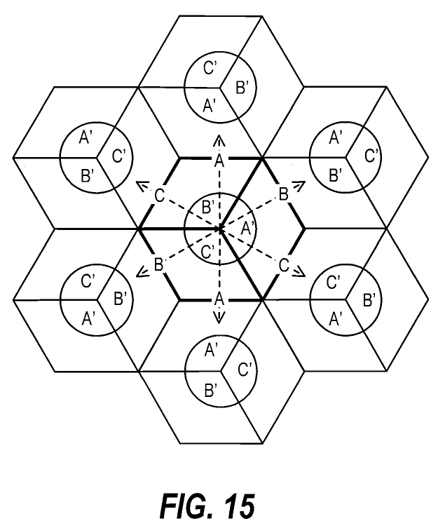

In FIG. 14, four carriers 32 (labeled A, B, C, and D) are used in a K=1 reuse plan which uses omnidirectional antennas 26 (FIG. 5). Low-power set 44 of carriers 32 includes only a single carrier 32 for each region 46, and high-power set 42 of carriers 32 includes three carriers 32 for each region 46. But the assignments of carriers 32 to the high-power and low-power sets 42 and 44 differ in different regions 46 so that a high-power version of a carrier 32 is repeatedly adjacent to a low-power version of the same carrier 32.

In FIG. 15, three carriers 32 (labeled A, B, and C) are used in a K=1 reuse plan which uses directional antennas 26 (FIG. 5) so that regions 46 are configured as sectors rather than cells. Low-power set 44 of carriers 32 includes only a single carrier 32 for each region 46, and high-power set 42 of carriers 32 includes two carriers 32 for each region 46. But the assignments of carriers 32 to the high-power and low-power sets 42 and 44 again differ in different regions 46 so that a high-power version of a carrier 32 is repeatedly adjacent to a low-power version of the same carrier 32.

In each of the FIG. 13-15 examples, all carriers 32 are assigned in each region 46, high-power set 42 includes at least two member carriers 32, low-power set 44 includes at least one member carrier 32, the number of members in low-power set 44 is no more than 50% of the number of members in high-power set 42, and data is transmitted from each base station 20 using every one of the carriers 32.

In still another alternate, and less preferred, embodiment of the present invention, carriers 32 assigned to low-power set 44 may actually be transmitted at a power of approximately zero so that no data is transmitted in the low-power set 44 of carriers 32. In other words, the few low-power carriers 32 are left fallow. This embodiment is nevertheless useful because it achieves system capacity improvements over conventional equal power, K=1 frequency reuse plans. And, since no data is transmitted in low-power set 44 of carriers 32, access terminals 76 need not implement processes to favor the selection of such carriers over other stronger carriers. But since the few carriers included in low-power set 44 are unused, system capacity suffers since it is lower than the system capacity achievable with the other embodiments discussed above.

In summary, at least one embodiment of the present invention provides a multi-carrier cellular communication system that achieves an efficient use of the spectrum while supporting boundary communications. System capacity is improved by efficiently allocating power to the available bandwidth. And, in accordance with at least one embodiment of the present invention, a multi-carrier cellular communication system uses inexpensive base stations that are compatible with smaller cell sizes, and can take advantage of inexpensive and less obtrusive omnidirectional antennas.

Although the preferred embodiments of the invention have been illustrated and described in detail, it will be readily apparent to those skilled in the art that various modifications and adaptations may be made therein without departing from the spirit of the invention or from the scope of the appended claims. For example, the transmitter discussed above may be configured to include multiple power amplifiers, and/or the antenna discussed above may be configured to have multiple antenna elements located proximate one another and driven by the multiple power amplifiers. The multiple power amplifiers may amplify the same RF bandwidth or separate portions of the RF bandwidth. In such equivalent variations, the multiple power amplifiers shall be viewed as being included in the transmitter and the multiple antenna elements shall be viewed as the antenna. Such modifications and adaptations which are obvious to those skilled in the art are to be included within the scope of the present invention.

What is claimed is:

1. In a communication system providing radio coverage over a plurality of distinct geographical regions in which a radio-frequency (RF) bandwidth is divided into a plurality of frequency-division multiplexed (FDM) forward link carriers and repeatedly reused throughout said regions, a method of communicating with an efficient allocation of power to bandwidth comprising:
providing an antenna for each of said distinct geographical regions;
assigning, for each of said distinct geographical regions, every one of said plurality of FDM forward link carriers to either a first set or a second set of said FDM forward link carriers;
transmitting, from said antenna associated with each of said distinct geographical regions, a radio-frequency signal using said first set of said FDM forward link carriers and said second set of said FDM forward link carriers, wherein:
a strongest member of said second set of said FDM forward link carriers is transmitted at lower power than a weakest member of said first set of FDM forward link carriers, and
said second set of said FDM forward link carriers has at least one of said FDM forward link carriers and at most 50% of the number of said FDM forward link carriers included in said first set of said FDM forward link carriers.

2. A method as claimed in claim 1 wherein said FDM forward link carriers are statically assigned to said first and second sets of said FDM forward link carriers.

3. A method as claimed in claim 1 wherein, for each of said distinct geographical regions, one of said FDM forward link carriers included in said second set of said FDM forward link carriers is included in said first set of said FDM forward link carriers for adjacent distinct geographical regions.

4. A method as claimed in claim 1 additionally comprising:
receiving at least a portion of said plurality of FDM forward link carriers at an access terminal;
operating said access terminal to identify a threshold data rate which is less than or equal to a maximum data rate expected from a single one of said plurality of FDM forward link carriers; and
operating said access terminal to select one of said FDM forward link carriers included in said second set of said FDM forward link carriers for receiving data when said one of said FDM forward link carriers included in said second set of said FDM forward link carriers is estimated to provide at least said threshold data rate.

5. A method as claimed in claim 1 additionally comprising:
receiving at least a portion of said plurality of FDM forward link carriers at an access terminal;
determining a signal-to-interference-and-noise ratio (SINR) at said access terminal for each of said plurality of FDM forward link carriers received at said access terminal; and
operating said access terminal to select one of said FDM forward link carriers included in said second set of said FDM forward link carriers for receiving data when said one of said FDM forward link carriers included in said second set of said FDM forward link carriers is determined to have a lower SINR than others of said FDM forward link carriers.

6. A method as claimed in claim 1 additionally comprising configuring said FDM forward link carriers in accordance with a TIA-856, Evolution-Data optimized (EV-DO), communication standard.

7. A method as claimed in claim 1 wherein said RF bandwidth is approximately 10 MHz in each of said distinct geographical regions, said first set of said FDM forward link carriers includes six members, and said second set of FDM forward link carriers includes one member.

8. A method as claimed in claim 1 wherein each antenna transmits each of said FDM forward link carriers included in said second set of said FDM forward link carriers at a power level greater than 0.001 times an average power level for all of said plurality of FDM forward link carriers assigned for said distinct geographical region of each antenna.

9. A method as claimed in claim 1 wherein:
said plurality of FDM forward link carriers is assigned to said distinct geographical regions in accordance with a frequency reuse pattern (K) of one; and
antennas for said distinct geographical regions transmit said plurality of FDM forward link carriers at different power levels within each of said distinct geographical regions.

10. A method as claimed in claim 1 wherein said at least a portion of said antennas are omnidirectional antennas.

11. A method as claimed in claim 1 wherein data is transmitted from each antenna over every one of said FDM forward link carriers in said first and second sets.

12. A method as claimed in claim 1 wherein, for each antenna, said strongest member of said second set of said FDM forward link carriers is transmitted at less than an average power level for all of said plurality of FDM forward link carriers assigned for said distinct geographical region of each antenna.

13. A method as claimed in claim 1 wherein, for each antenna, said strongest member of said second set of said FDM forward link carriers is transmitted at less than 0.5 times an average power per carrier of said first set of FDM forward link carriers assigned for said distinct geographical region of each antenna.

14. A method as claimed in claim 1 wherein said second set of FDM forward link carriers has no more than one of said FDM forward link carriers.

15. In a cellular communication system providing radio coverage over a plurality of distinct geographical regions in which a radio-frequency (RF) bandwidth is divided into a plurality of frequency-division multiplexed (FDM) forward link carriers and repeatedly reused throughout said regions, a method of communicating with an efficient allocation of power to bandwidth comprising:
providing an antenna for each of said distinct geographical regions;
assigning, for each of said distinct geographical regions, all of said plurality of FDM forward link carriers to one of a first set and a second set of said FDM forward link carriers;
transmitting, from said antenna associated with each of said distinct geographical regions, a radio-frequency signal using said first set of said FDM forward link carriers and said second set of said FDM forward link carriers, wherein:
a strongest member of said second set of said FDM forward link carriers is transmitted at lower power than a weakest member of said first set of said FDM forward link carriers,
said first set of said FDM forward link carriers has at least one of said FDM forward link carriers,
said second set of said FDM forward link carriers has at least one of said FDM forward link carriers, and
data is transmitted over every one of said FDM forward link carriers assigned in said first and second sets.

16. A method as claimed in claim 15 wherein said FDM forward link carriers are statically assigned to said first and second sets of said FDM forward link carriers.

17. A method as claimed in claim 15 wherein, for each of said distinct geographical regions, one of said FDM forward link carriers included in said second set of said FDM forward link carriers is included in said first set of said FDM forward link carriers for adjacent distinct geographical regions.

18. A method as claimed in claim 15 additionally comprising:
receiving at least a portion of said plurality of FDM forward link carriers at an access terminal;
operating said access terminal to identify a threshold data rate which is less than or equal to a maximum data rate expected from a single one of said plurality of FDM forward link carriers; and
operating said access terminal to select one of said FDM forward link carriers included in said second set of said FDM forward link carriers for receiving data when said one of said FDM forward link carriers included in said second set of said FDM forward link carriers is estimated to provide at least said threshold data rate.

19. A method as claimed in claim 15 additionally comprising:
receiving at least a portion of said plurality of FDM forward link carriers at an access terminal;
determining a signal-to-interference-and-noise ratio (SINR) at said access terminal for each of said plurality of FDM forward link carriers received at said access terminal; and
operating said access terminal to select one of said FDM forward link carriers included in said second set of said FDM forward link carriers for receiving data when said one of said FDM forward link carriers included in said second set of said FDM forward link carriers is determined to have a lower SINR than others of said FDM forward link carriers.

20. A method as claimed in claim 15 wherein, for each of said distinct geographical regions, said strongest member of said second set of said FDM forward link carriers is transmitted at less than an average power level for all of said plurality of FDM forward link carriers.

21. A method as claimed in claim 15 wherein, for each of said distinct geographical regions, said strongest member of said second set of said FDM forward link carriers is transmitted at less than 0.5 times an average power per carrier of said first set of FDM forward link carriers.

22. A method as claimed in claim 15 wherein said second set of FDM forward link carriers has no more than one of said FDM forward link carriers.

23. A cellular communication system providing radio coverage over a plurality of distinct geographical regions in which a radio-frequency (RF) bandwidth is divided into a plurality of frequency-division multiplexed (FDM) forward link carriers and repeatedly reused throughout said regions, said system comprising:
a plurality of antennas having a one-to-one correspondence with said plurality of distinct geographical regions; and
a plurality of transmitters having a one-to-one correspondence with said plurality of distinct geographical regions and with said plurality of antennas, wherein:
each transmitter couples to one of said plurality of antennas,
each transmitter is included in a base station configured to assign all of said plurality of FDM forward link carriers to either a first set of said FDM forward link carriers or a second set of said FDM forward link carriers,
each base station is configured to assign at least one of said plurality of FDM forward link carriers to said second set of said FDM forward link carriers,
each base station is configured to assign to said second set of said FDM forward link carriers no more than 50% of the number of said FDM forward link carriers assigned to said first set of said FDM forward link carriers,
each transmitter is configured to transmit a radio-frequency signal using said first set of said FDM forward link carriers and said second set of said FDM forward link carriers, and
each transmitter is configured to transmit a strongest member of said second set of said FDM forward link carriers at lower power than a weakest member of said first set of said FDM forward link carriers.

24. A cellular communication system as claimed in claim 23 wherein said FDM forward link carriers are statically assigned to said first and second sets of said FDM forward link carriers.

25. A cellular communication system as claimed in claim 23 wherein, for each of said transmitters, an FDM forward link carrier included in said second set of said FDM forward link carriers is included in said first set of said FDM forward link carriers for adjacent distinct geographical regions.

26. A cellular communication system as claimed in claim 23 additionally comprising an access terminal configured to receive at least a portion of said plurality of FDM forward link carriers, wherein said access terminal has a controller configured to identify a threshold data rate which is less than or equal to a maximum data rate expected from a single one of said plurality of FDM forward link carriers, and to select one of said FDM forward link carriers included in said second set of said FDM forward link carriers for receiving data when said one of said FDM forward link carriers included in said second set of said FDM forward link carriers is estimated to provide at least said threshold data rate.

27. A cellular communication system as claimed in claim 23 additionally comprising an access terminal configured to receive at least a portion of said plurality of FDM forward link carriers, wherein said access terminal has a controller configured to determine a signal-to-interference-and-noise ratio (SINR) at said access terminal for each of said plurality of FDM forward link carriers received at said access terminal, and to select one of said FDM forward link carriers included in said second set of said FDM forward link carriers for receiving data when said one of said FDM forward link carriers included in said second set of said FDM forward link carriers is determined to have a lower SINR than others of said FDM forward link carriers.

28. A cellular communication system as claimed in claim 23 wherein said RF bandwidth is approximately 10 MHz, said first set of said FDM forward link carriers includes six members, and said second set of said FDM forward link carriers includes one member.

29. A cellular communication system as claimed in claim 23 wherein each transmitter transmits each of said FDM forward link carriers included in said second set of said FDM forward link carriers at a power level greater than 0.001 times an average power level for all of said plurality of FDM forward link carriers.

30. A cellular communication system as claimed in claim 23 wherein, for each transmitter, said strongest member of said second set of said FDM forward link carriers is transmitted at less than an average power level for all of said plurality of FDM forward link carriers assigned at said base station.

31. A cellular communication system as claimed in claim 23 wherein, for each transmitter, said strongest member of said second set of said FDM forward link carriers is transmitted at less than 0.5 times an average power per carrier of said first set of FDM forward link carriers.

32. A cellular communication system as claimed in claim 23 wherein said second set of FDM forward link carriers has no more than one of said FDM forward link carriers.

33. A cellular communication system as claimed in claim 23 wherein at least a portion of said antennas are omnidirectional antennas.

34. A cellular communication system as claimed in claim 23 wherein data is transmitted from each transmitter over every one of said FDM forward link carriers assigned in said first and second sets.

35. In an access terminal of a cellular communication system providing radio coverage over a plurality of distinct geographical regions in which a radio-frequency (RF) bandwidth is divided into a plurality of frequency-division multiplexed (FDM) forward link carriers and repeatedly reused throughout said regions, a method of communicating with an efficient allocation of power to bandwidth comprising:
receiving at least a portion of said plurality of FDM forward link carriers, said portion of said plurality of FDM forward link carriers including an FDM forward link carrier preferred for use by said cellular communication system;
identifying a threshold data rate which is less than or equal to a maximum data rate expected from a single one of said plurality of FDM forward link carriers;
estimating a data rate for each of said portion of received FDM forward link carriers;
selecting said preferred one of said FDM forward link carriers for receiving data when said preferred one of said FDM forward link carriers is estimated to provide at least said threshold data rate.

36. A method as claimed in claim 35 wherein:
said estimating activity comprises determining a signal-to-interference-and-noise ratio (SINR) at said access terminal for each of said plurality of FDM forward link carriers received at said access terminal; and
said selecting activity selects said preferred one of said FDM forward link carriers for receiving data when said preferred one of said FDM forward link carriers is determined to have a lower SINR than others of said FDM forward link carriers.
